(19) United States
(12) Patent Application Publication
(10) Pub. No.: US 2015/0293690 A1
(43) Pub. Date: Oct. 15, 2015

(54) METHOD FOR USER INTERFACE DISPLAY AND ELECTRONIC DEVICE USING THE SAME

(71) Applicant: Acer Incorporated, New Taipei City (TW)

(72) Inventors: Kai-Ping Chang, New Taipei City (TW); Ling-Fan Tsao, New Taipei City (TW)

(21) Appl. No.: 14/488,298

(22) Filed: Sep. 17, 2014

(30) Foreign Application Priority Data
Apr. 15, 2014 (TW) 103113691

(51) Int. Cl. G06F 3/0488; G06F 17/21; G06F 3/041

(52) U.S. Cl. CPC G06F 3/04883; G06F 3/0412; G06F 3/0416; G06F 17/211

(57) ABSTRACT

A method for a user interface display, suitable for an electronic device with a touch screen, is provided. The method includes the following steps: receiving a plurality of operating signals corresponding to a plurality of writing strokes on the touch screen, and displaying a plurality of characters respectively according to the operating signals, wherein each of the characters includes at least one of the writing strokes; calculating an average width of the characters, and calculating a distance threshold according to the average width of the characters and a size of the touch screen; deriving a margin distance between the last character of the characters and a margin of the touch screen; when the margin distance is shorter than the distance threshold, shifting a display position of the characters on the touch screen according to the margin distance and the size of the touch screen.

### CROSS-REFERENCE TO RELATED APPLICATION

This application claims the priority benefit of Taiwan application serial no. 103113691, filed on Apr. 15, 2014. The entirety of the above-mentioned patent application is hereby incorporated by reference herein and made a part of this specification.

### FIELD OF THE INVENTION

The invention relates to an electronic device. More particularly, the invention relates to an electronic device and a method for a user interface display thereof.

### DESCRIPTION OF RELATED ART

As mobile electronic devices, e.g., smartphones or tablet computers, are widely used, it is getting more and more common for users to execute editing operations such as inputting words and scribbling by fingers or stylus pens on mobile electronic devices. However, the first obstacle which the users may encounter is the limited screen sizes of the mobile electronic devices, which provide limited editing space for the users to put handwritten words.

### SUMMARY OF THE INVENTION

The invention provides a method for a user interface display and an electronic device, which make it more convenient for a user to input words in a touch screen of an electronic device.

The method for the user interface display of the invention is suitable for an electronic device with a touch screen, which includes the following steps: first of all, a plurality of operating signals corresponding to a plurality of writing strokes are received on the touch screen, and a plurality of characters are displayed respectively according to the operating signals, wherein each of the characters includes at least one of the writing strokes; then, an average width of the characters is calculated, and a first distance threshold is calculated according to an average width of the characters and a size of the touch screen; next, a margin distance between the last character of the characters and a margin of the touch screen is derived; when the margin distance is shorter than the first distance threshold, a display position of the characters on the touch screen is shifted according to the margin distance and the size of the touch screen.

The electronic device of the invention includes a touch screen and a processing unit. The touch screen displays a user interface and receives a plurality of operating signals corresponding to a plurality of writing strokes. The processing unit is coupled to the touch screen, receives the operating signals, and displays a plurality of characters respectively according to the operating signals on the touch screen, wherein each of the characters includes at least one of the writing strokes. The processing unit calculates an average width of the characters, and also calculates a first distance threshold according to the average width of the characters and a size of the touch screen. The processing unit derives a margin distance between the last character of the characters and a margin of the touch screen. When the margin distance is shorter than the first distance threshold, the processing unit shifts a display position of the characters in the user interface displayed on the touch screen according to the margin distance and the size of the touch screen.

In light of the above, the invention provides a method for a user interface display and an electronic device, which may dynamically modify contents of the user interface, such that when the user inputs words by handwriting or by other means, the user may conveniently edit words without being limited by a size of a screen.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method for a user interface display according to an embodiment of the invention.

FIG. 2 is a block diagram illustrating functions of an electronic device according to an embodiment of the invention.

FIG. 3 to FIG. 4 are schematic diagrams illustrating relationships between characters and a user interface according to an embodiment of the invention.

FIG. 5A to FIG. 5B are schematic diagrams illustrating relationships between characters and a user interface according to an embodiment of the invention.

FIG. 6 is a flowchart illustrating a method for a user interface display according to an embodiment of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

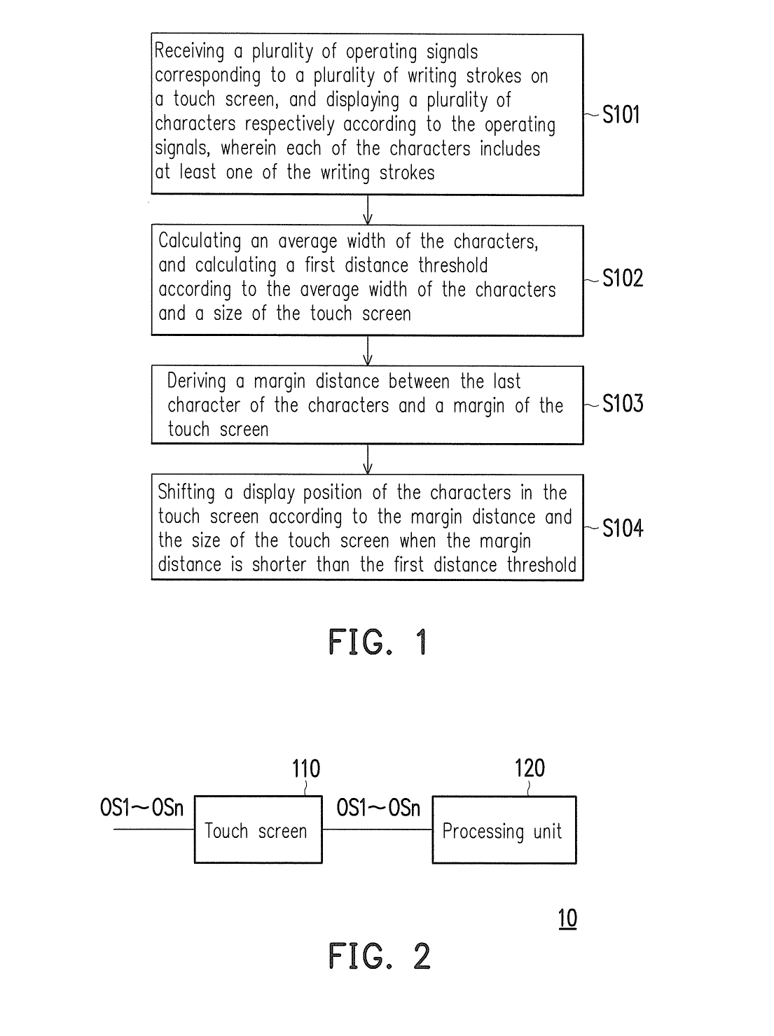

FIG. 1 is a flowchart illustrating a method for a user interface display according to an embodiment of the invention. Here, the method for a user interface display would be suitable for an electronic device with a touch screen, e.g., a mobile electronic device such as a smart phone, a tablet computer, or a notebook computer with a touch screen; or an electronic device such as a personal computer (PC) with a touch screen and an all in one PC (AIO).

With reference to FIG. 1, first of all, in Step S101, a plurality of operating signals corresponding to a plurality of writing strokes on the touch screen are received, and a plurality of characters according to the operating signals are respectively displayed, wherein each of the characters would include at least one of the writing strokes. Then, in Step S102, an average width of the characters is calculated, and a first distance threshold is calculated according to the average width of the characters and a size of the touch screen. Next, a margin distance between the last character of the characters and a margin of the touch screen is derived. When the margin distance is shorter than the first distance threshold, a display position of the characters on the touch screen is shifted according to the margin distance and the size of the touch screen.

FIG. 2 is a block diagram illustrating functions of an electronic device according to an embodiment of the invention. With reference to FIG. 2, an electronic device 10 includes a touch screen 110 and a processing unit 120. The touch screen 120 is configured for displaying a user interface (e.g., a user interface of an operating system run by the processing unit 120, or a user interface of a particular software), and receiving a plurality of operating signals OS1-OSn corresponding to a plurality of writing strokes.

The processing unit 120 is coupled to the touch screen 110. The touch screen 110 receives the operating signals OS1-OSn. The processing unit 120 displays a plurality of characters on the touch screen 110 respectively according to the operating signals OS1-OSn, wherein each of the characters includes at least one of the writing strokes. The processing unit 120 further calculates an average width of the characters, and calculates a first distance threshold according to the average width of the characters and a size of the touch screen 110. The processing unit 120 derives a margin distance between the last character of the characters and a margin of the touch screen 110. When the margin distance is shorter than the first distance threshold, the processing unit 120 shifts a display position of the characters in the user interface displayed on the touch screen 110 according to the margin distance and the size of the touch screen 110.

In the invention, a user may interact with the touch screen 110 either in a contact manner or in a non-contact manner by using a stylus pen, a finger, or other touch objects, such that the touch screen 110 receives the operating signals (i.e., the operating signals OS1-OSn) corresponding to operations of the user. Each of the operating signals OS1-OSn described in the invention all respectively corresponds to a single writing stroke generated from an interaction between the user and the touch screen 110, and a character may include one or more writing strokes. Numbers of the writing strokes included in one character may depend on the language in use. For example, most lowercase English alphabets may be completed with one single writing stroke, while one or more writing strokes would be need to complete a Chinese character.

The invention focuses primarily on scenarios when the user inputs words by operating on the touch screen 110 with a stylus pen or a finger. In such scenarios, the writing strokes inputted by the user may be preserved directly, e.g., be preserved as a handwriting note, or converted into a text, by an input software (e.g., an application program or a subsidiary application procedure in an operation system operating by the processing unit 120), but the invention is not limited thereto. Since words (characters) directly inputted on the touch screen 110 by the user are usually presented in a bigger proportion, if a size of the touch screen 110 relatively smaller, e.g., the screen size of a smaller smart phone or a smaller tablet computer, the touch screen 110 may not have any extra space for writing after one or two words are inputted. Therefore, the user has to wait for the present writing strokes/characters to be saved by the electronic device and wait until the writing strokes displayed on the touch screen 110 are cleared before continuously inputting words/characters on the touch screen 110. Such a procedure may bring unsmooth user experience to users of the electronic device 10.

Accordingly, in the invention, such as embodiments shown in FIGS. 1-2, according to the size of the touch screen 110, and sizes and/or intervals of the characters currently displayed on the touch screen 110, the electronic device 10 would determine whether the remaining space on the touch screen 110 (which may correspond to the margin distance and the first distance threshold) is enough for a user to input another character. When the remaining space on the touch screen 110 may not be enough for the user to input another character by handwriting, the processing unit 120 would shift the characters that are already displayed on the touch screen 110, such that a user interface displayed on the touch screen 110 still provides enough space for the user to input words/characters. Embodiments accompanied with drawings are described in the following to illustrate the invention in more details.

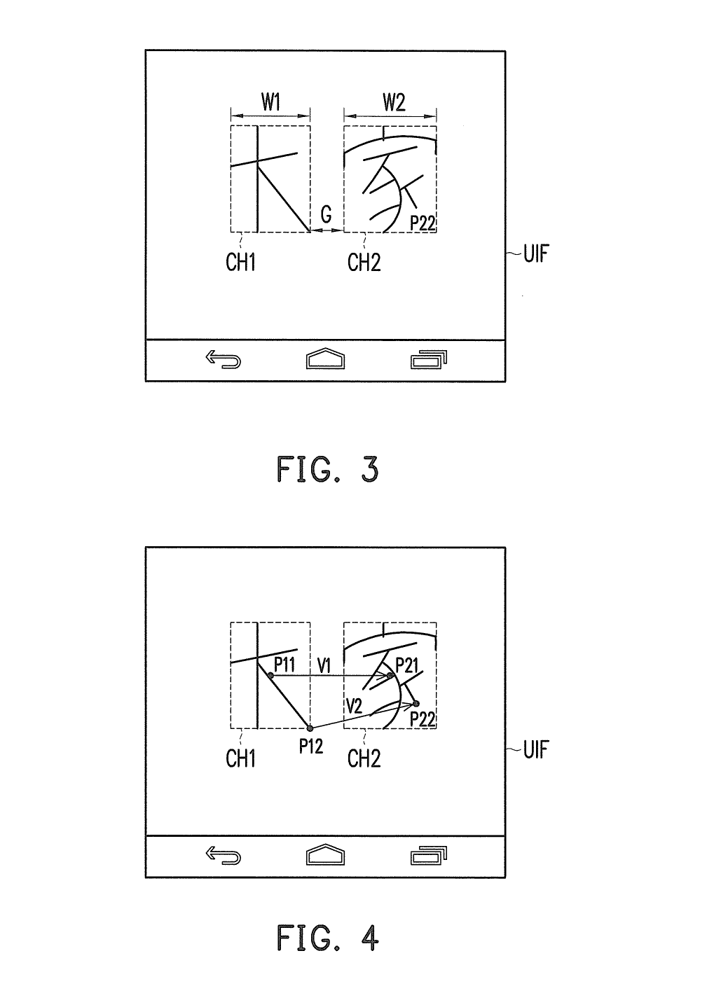

FIG. 3 is a schematic diagram illustrating a relationship between characters and a user interface according to an embodiment of the invention. With reference to FIG. 3, in the embodiment illustrated in FIG. 3, a user interface UIF is displayed on the touch screen 110 of the electronic device 10, which includes characters CHI and CH2 displayed correspondingly by an interaction between the user and the touch screen 110, wherein the characters CH1 and CH2 includes a plurality of writing strokes. For example, the character CH1 is a “ [symbol] ” character, which includes three writing strokes (i.e., approximately corresponding to strokes of the character), and the three writing strokes correspond to three operating signals (e.g., operating signals OS1 to OS3). In the present embodiment, the processing unit 120 would continuously monitor the interaction between the user and the touch screen 110 through the touch screen 110, and determines a relationship between the operating signals OS1-OSn and the characters accordingly. Intuitively, when the user writes the characters, a certain extent of time interval exists between one character and the next character, e.g., the time interval is generated when the user moves a hand from a position for writing one character to a position for writing the next character, or when the user spends time for thinking how to write the next character or what to write next. The processing unit 120 may accordingly monitor the time intervals between the operating signals OS1-OSn and determine if a time interval between the operating signals OS1-OSn is longer than a preset value (e.g., 0.5 milliseconds). When the time interval (e.g., the time interval between the operating signal OSk and OSk+1, wherein k is smaller than n) is longer than the preset value, the processing unit 120 determines that the operating signals (e.g., operating signals OS1 to OSk) from the previous ones under the same determination (i.e., the time interval is longer than the preset value) to the ones currently received correspond to one character.

In this way, the processing unit 120 may determine the operating signals OS1-OSn currently received are in correspondence with how many characters. After determining and obtaining the corresponding relationship between the operating signals OS1-OSn and the characters, the processing unit 120 may derive a size of each character (i.e., a length and width of a character) according to the writing strokes corresponded to the operating signals OS1-OSn, and calculate to derive an average width of the current characters. For example, in the embodiment illustrated in FIG. 3, the characters CH1 and CH2 have widths W1 and W2, respectively. The average width of the characters is derived by adding the widths W1 and W2 and then divided by 2, but the invention is not limited thereto, for example, more characters corresponding to the operating signals OS1-OSn may be displayed at the same time on the touch screen 110.

In addition, the processing unit 120 may also derive an interval (e.g., an interval G as shown in FIG. 2) between the characters at the same time when the size of each character is derived, and calculate an average interval of the characters at the same time when the average width of the characters is calculated. Meanwhile, the processing unit 120 may determine a first margin threshold according to the average width of the characters, the average interval of the characters, and the size of the touch screen 110. For example, the first margin threshold may be set to be equal to the average width of the characters, or to be equal to a sum of the average width of the characters and the average interval of the characters.

In another aspect, when it is determined that the processing unit 120 has to shift a display position of the character(s) on the touch screen 110, the processing unit 120 also may also need to determine a shifting direction of the character and an amount of a shift of the display position. Herein, in an embodiment of the invention, for the shifting direction of the character(s), the processing unit 120 would determine a writing direction of a character, then according to the writing direction, determines which of the margin of the touch screen 110 the writing direction heads toward to, and calculates a margin distance between the last character and the margin. Next, the processing unit 120 shifts the display position of the character on the touch screen 110 toward a direction opposite to the writing direction according to the margin distance and the size of the touch screen 110.

FIG. 4 is a schematic diagram illustrating a relationship between characters and a user interface according to an embodiment of the invention. With reference to FIG. 4, the user interface UIF and the characters CH1 and CH2 illustrated in FIG. 4 are the same with those in the embodiment illustrated in FIG. 3, but vectors V1 and V2 for determining the writing directions are further marked in an embodiment illustrated in FIG. 4. Here, the vector V1 points from a central point P11 of the character CH1 toward a central point P21 of the character CH2. After a corresponding relationship between the operating signals OS1-OSn and the characters is obtained, the central points P11 and P21 of the characters CH1 and CH2 may be derived by calculations in coordination with coordinates. The vector V2 points from an ending point P12 of the character CH1 toward an ending point P22 of the character CH2. The ending points P12 and P22 of the characters CH1 and CH2 are ends of the last writing stroke of the characters CH1 and CH2, which, in other words, are positions on the touch screen 110 corresponded by the operating signals (e.g., the operating signal OSk) when the time interval between the operating signals is determined to be longer than the preset value. Since an acquirement of the vector V2 does not take extra calculations, the vector V2 is easier to be acquired. However, for determining the writing direction, and direction of the vector V1 may match an actual writing direction of the user more accurately. The processing 120 may determine the above writing direction according to one of the vectors V1 and V2, or a combination of the vectors V1 and V2. When there are more than two characters in the user interface UIF is, the processing unit 120 may acquire the vectors V1 and V2 by the above method, superpose the vectors V1 and V2 between each of the characters, and determine the writing direction according to a sum (i.e., superposition) of the vector V1 or the vector V2 between each of the characters.

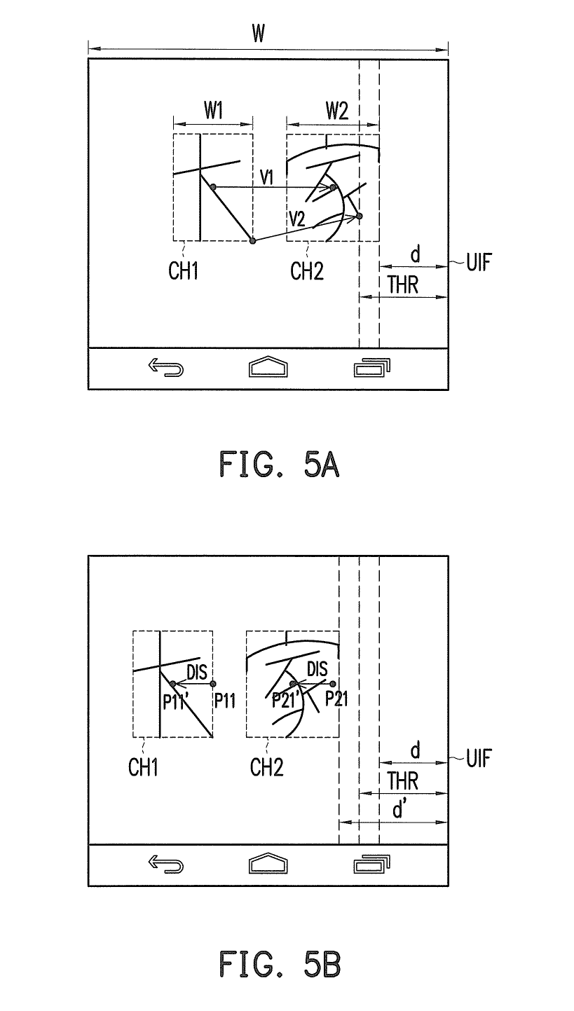

FIG. 5A and FIG. 5B are schematic diagrams illustrating relationships between characters and a user interface according to an embodiment of the invention. With reference to FIG. 5A, in continuing the embodiments illustrated in FIGS. 3 and 4, the processing unit 120, first of all, determines that currently there are the two characters CH1 and CH2 displayed on the user interface UIF according to the received operating signals OS1-OSn and the time interval thereof. Then, the processing unit 120 calculates an average width of the characters and an average interval of the characters (i.e., equal to the interval G) of the characters according to the widths W1 and W2 of the characters CH1 and CH2, and sets a first distance threshold THR as the average width of the characters. Next, the processing 120 determines that the characters are written towards a right direction according to the vector V1 and the vector V2 (i.e., on the right side of FIG. 5). According to the writing direction toward to the right, the processing unit 120 may determine that a margin to which the writing direction heads toward is the right margin of the touch screen 110.

Meanwhile, the processing unit 120 may calculate a margin distance d between the last character (i.e., the character CH2) and the margin (i.e., the right margin of the touch screen 110). In the embodiment illustrated in FIG. 5A, the processor unit 120 may determine that the margin distance d is shorter than the first distance threshold THR. Accordingly, the processing unit 120 shifts a display position of the characters toward a direction opposite to the writing direction (i.e., to the left side of FIG. 5A) according to the margin distance d and the size of the touch screen 110 (e.g., a width W of the user interface UIF in the present embodiment).

Next, with reference to FIG. 5B, the characters CH1 and CH2 in FIG. 5B has shifted a displacement DIS toward the direction opposite to the writing direction. For example, the central points P11 and P21 of the characters CH1 and CH2 have shifted to central points P11′ and P21′. A value of the displacement DIS could be determined accordingly based on actual implementing scenarios. The displacement DIS of the present embodiment equals to a sum in which the average width of the characters pluses the average interval of the characters and minuses the margin distance d, such that a margin distance d′ after a shift approximately equals to a sum of the average width of the characters and the average interval of the characters, so that there is enough space between the last character (the character CH2) and the margin (i.e., the right margin) for the user to input another character by interacting with the touch screen 110 again.

In addition, in another embodiment of the invention, the displacement DIS equals to a sum which the width W of the user interface UIF minuses the margin distance d, such that the characters CH1 and CH2 exceed a display range of the user interface UIF so as to provide a maximum input area (i.e., the entire area of the user interface UIF/the size of the touch screen 110) for the user. In fact, the character CH2 is still aligned with a left margin of the user interface UIF in background mode. Accordingly, the processing unit 120 may still align a character newly inputted with the characters CH1 and CH2.

The processing unit 120 of the present embodiment may also accumulate the degree of the displacement DIS. When the displacement DIS is longer than a second distance threshold, the processing unit 120 executes a segmentation procedure by shifting a character input position of a current character to a position below the inputted character(s) so as to aligning the current character with the first character (e.g., the character CH1). Such procedure is the same as a movement of changing lines in a text editor operated by the user. Furthermore, in an embodiment of the invention, the processing unit 120 further monitors and analyzes the writing strokes. When the processing unit 120 detects that a writing stroke corresponded by one of the operating signals OS1-OSn matches a punctuation mark, the processing unit 120 also executes the segmentation procedure, but the invention is not limited to the above arrangement. The second distance threshold may correspond to a maximum width of the characters recorded in a data format of the processing unit 120, but the invention is not limited to the above description.

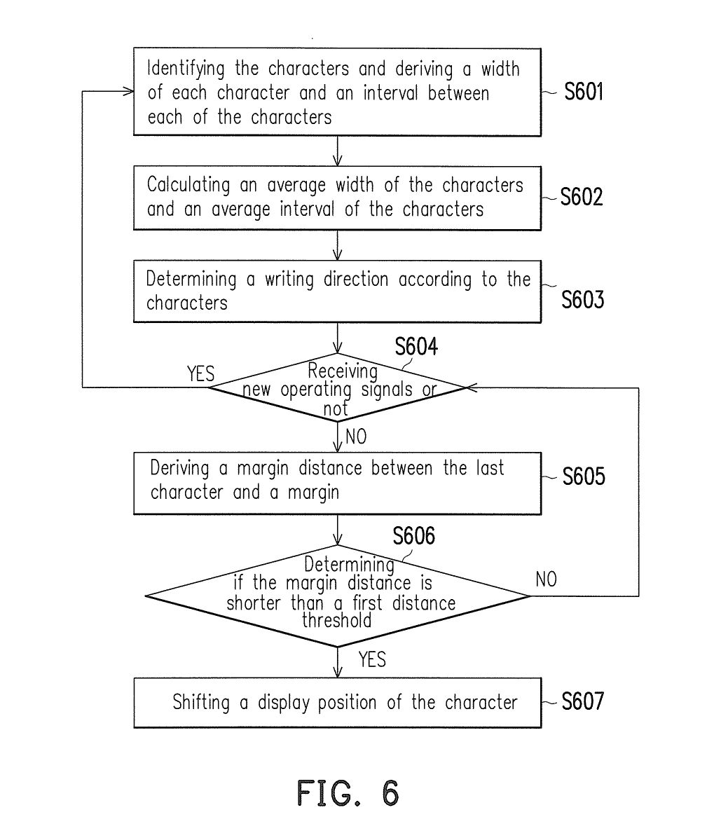

FIG. 6 is a flowchart illustrating a method for a user interface display according to an embodiment of the invention. Herein, comparing to the embodiment illustrated in FIG. 1, the embodiment illustrated in FIG. 6 provides more implementation details of the method for the user interface display. With reference to FIG. 2 and FIG. 6, first of all, the processing unit 120 receives the operating signals OS1-OSn by the touch screen 110, and identifies characters corresponded by the operating signals OS1-OSn by monitoring a time interval between the operating signals OS1-OSn. Then, the processing unit 120 also derives a width of each character and an interval between each of the characters when identifying the characters (Step S601).

Next, the processing unit 120 calculates an average width of the characters and an average interval of the characters corresponded by the operating signals OS1-OSn (Step S602). The processing unit 120 further determines a writing direction (e.g., determines the writing direction according to the vectors V1 and V2 illustrated in FIG. 4) according to the characters and a margin (equals to the margin of the user interface UIF) of the touch screen 110 corresponded by the writing direction (Step S603).

Afterwards, the processing unit 120 determines whether new operating signals are received again (Step S604) from the touch screen 110. If the processing unit 120 receives new operating signals from the touch screen 110, the processing unit 120 would then repeat the above steps S601 to S603. If the processing unit 120 does not receive any new operating signal from the touch screen 110, then the processing unit 120 derives a margin distance between the last character (e.g., the character CH2 as shown in FIG. 5A) of the current displayed characters and a margin of a corresponding writing direction (Step S605).

After deriving the margin distance, the processor unit 120 determines if the margin distance is shorter than a first distance threshold (Step S606). If the margin distance is shorter than the first distance threshold, then the processing unit 120 shifts a display position of the character(s) currently displayed (e.g., as shown in FIG. 5, shifting the displacement DIS toward a direction opposite to the writing direction). If the processing unit 120 determines that the margin distance is still longer than the first distance threshold, the processing unit 120 then continues to detect if new operating signals are received from the touch screen 110 (Step S604).

In summary, the invention provides a method for a user interface display and an electronic device using the same, capable of performing a calculation with an algorithm to determine if a margin distance that corresponds to an adjustment need of the of a handwriting area is reached according to characteristics of inputting words by handwriting of a user, (i.e., by interacting with a touch screen of an electronic device by a finger, a stylus pen or other touch objects), so as to provide a display environment where a handwritten character is not limited by a size of a screen of a mobile device. Accordingly, without being limited by the size of the screen, the user overcomes inconvenience of discontinuous handwritings and the user experience of inputting words by handwriting is improved.

Although the invention has been disclosed with reference to the aforesaid embodiments, they are not intended to limit the invention. It will be apparent to those skilled in the art that various modifications and variations can be made to the structure of the disclosed embodiments without departing from the scope or spirit of the invention. In view of the foregoing, it is intended that the disclosure cover modifications and variations of the specification provided they fall within the scope of the following claims and their equivalents.

What is claimed is:

1. A method for a user interface display suitable for an electronic device with a touch screen, comprising:
receiving a plurality of operating signals corresponding to a plurality of writing strokes on the touch screen, and displaying a plurality of characters respectively according to the operating signals, wherein each of the characters comprises at least one of the writing strokes;
calculating an average width of the characters, and calculating a first distance threshold according to the average width of the characters and a size of the touch screen;
deriving a margin distance between the last character of the characters and a margin of the touch screen; and
shifting a display position of the characters on the touch screen according to the margin distance and the size of the touch screen when the margin distance is shorter than the first distance threshold.

2. The method for a user interface display as claimed in claim 1, wherein the step of calculating the first distance threshold comprises:
calculating an average interval of the characters;
calculating the first distance threshold according to the average interval of the characters, the average width of the characters, and the size of the touch screen.

3. The method for a user interface display as claimed in claim 1, wherein:
before the step of shifting the display position of the characters on the touch screen, the method comprises:
determining a writing direction of the characters; and
the step of shifting the display position of the characters on the touch screen comprises:
shifting the display position of the characters on the touch screen toward a direction opposite to the writing direction according to the margin distance and the size of the touch screen.

4. The method for a user interface display as claimed in claim 1, wherein the operating signals comprises n operating signals, and the step of receiving the plurality of operating signals on the touch screen and displaying the plurality of characters respectively according to the operating signals comprises:
continuously monitoring a time interval between the operating signals, wherein when the time interval between a k^{th} operating signal and (k+1)^{th} operating signal is longer than a preset value, the operating signals from the 1^{st} to the k^{th} are determined to be one of the characters, wherein k is a integer value between 0 and n.

5. The method for a user interface display as claimed in claim 1, wherein after the step of shifting the display position of the characters on the touch screen, the method further comprises:
recording a migration distance of the characters;
executing a segmentation procedure when the migration distance is longer than a second distance threshold, wherein the segmentation procedure comprises:
aligning an character input position with a first character of the characters.

6. The method for a user interface display as claimed in claim 5, wherein after the step of shifting the display position of the characters on the touch screen, the method further comprises:
continuously receiving and analyzing the operating signals, executing the segmentation procedure when the writing stroke corresponded by one of the operating signals coincides with a punctuation mark.

7. An electronic device, comprising:
a touch screen for displaying a user interface and receiving a plurality of operating signals corresponding to a plurality of writing strokes; and
a processing unit coupled to the touch screen, receiving the operating signals, displaying a plurality of characters respectively according to the operating signals on the touch screen, wherein each of the characters comprises at least one of the writing strokes;
wherein the processing unit calculates an average width of the characters, and calculates a first distance threshold according to the average width of the characters and a size of the touch screen;
the processing unit derives a margin distance between the last character of the characters and a margin of the touch screen; and
when the margin distance is shorter than the first distance threshold, the processing unit shifts a display position of the characters in the user interface displayed on the touch screen according to the margin distance and the size of the touch screen.

8. The electronic device as claimed in claim 7, wherein:
the processing unit calculates an average interval of the characters;
the processing unit calculates a first distance threshold according to the average interval of the characters, the average width of the characters, and the size of the touch screen.

9. The electronic device as claimed in claim 7, wherein:
the processing unit determines a writing direction of the characters; and
the processing unit shifts the display position of the characters on the touch screen toward a direction opposite to the writing direction according to the margin distance and the size of the touch screen.

10. The electronic device as claimed in claim 7, wherein:
the operating signals comprises n operating signals; and
the processing unit continuously monitors a time interval between the operating signals, wherein when the time interval between k^{th} operating signal and (k+1)^{th} operating signal is longer than a preset value, the processing unit determines the operating signals from the 1^{st} to the k^{th} to be one of the characters, wherein k is a integer value between 0 and n.

11. The electronic device as claimed in claim 7, wherein:
the processing unit records a migration distance of the characters;
when the migration distance is longer than a second distance threshold, the processing unit executes a segmentation procedure, wherein the sementation procedure comprises:
aligning an character input position with a first character of the characters.

12. The electronic device as claimed in claim 7, wherein:
the processing unit continuously receives and analyzes the operating signals, when the writing stroke corresponded by one of the operating signals coincides with a punctuation mark, the processing unit executes the segmentation procedure.
